(19) United States
(12) Patent Application Publication
(10) Pub. No.: US 2024/0180310 A1
(43) Pub. Date: Jun. 6, 2024

(54) HEATER

(71) Applicant: Dyson Technology Limited, Wiltshire (GB)

(72) Inventors: Kyle James CRAWFORD, Cirencester (GB); Benjamin James HOGAN, Malmesbury (GB); Mohd Awaluddin A RAHMAN, Johor (MY)

(73) Assignee: Dyson Technology Limited, Wiltshire (GB)

(21) Appl. No.: 18/285,472

(22) PCT Filed: Mar. 28, 2022
(86) PCT No.: PCT/GB2022/050766

§ 371 Date: Oct. 3, 2023

(30) Foreign Application Priority Data
Apr. 8, 2021 (GB) 2104988.7

(51) Int. Cl. A45D 20/12; H05B 3/14; H05B 3/28

(52) U.S. Cl. CPC A45D 20/12; H05B 3/141; H05B 3/283

(57) ABSTRACT

A heater coupon including a ceramic block having a first surface and a second surface, at least one heater trace formed within the ceramic block and a connector for electrically connecting the at least one heater trace to an external wire wherein the connector comprises a first connecting arm for connecting with respect to the first surface of the ceramic block and a second connecting arm for connecting with respect to the second surface of the ceramic block. The connector may be located at an end of the ceramic block. The ceramic block may be formed from a plurality of layers of ceramic material. The at least one heater trace may be screen printed onto one of the layers of ceramic sheet that form the ceramic block. The ceramic block may be provided with a first recess for accommodating the first connecting arm and a second recess for accommodating the second connecting arm.

### FIELD OF THE INVENTION

This invention relates to a heater, in particular a heater having a ceramic heater coupon suitable for use in a handheld appliance such as a hair care appliance.

### BACKGROUND OF THE INVENTION

Heaters can be in the form of a resistive wire wound around an insulating scaffold. Alternative types of heater can use a heater track printed onto a polyamide sheet such as Kapton or a ceramic heater coupon having an embedded heater track formed from a trace made from an electrically conductive material such as but not limited to tungsten. In order to dissipate heat from the ceramic heater coupon cooling fins may be provided.

An electrical connection into and out of the ceramic heater coupon may involve electrically connecting the trace to live and neutral wires. One way to achieve this is to make a via from a surface of the heater coupon to the depth of the trace and backfill the via with solder then connect to an end of a wire. Such surface mounted electrical connections are at risk of being damaged as they mounted proud of a surface of the heater coupon.

### SUMMARY OF THE INVENTION

The present invention seeks to provide an electrical connection with a heater coupon which mitigates the abovementioned problem.

The present invention provides a heater coupon comprising a ceramic block having a first surface and a second surface, at least one heater trace formed within the ceramic block and a connector for electrically connecting the at least one heater trace to an external wire wherein the connector comprises a first connecting arm for connecting with respect to the first surface and a second connecting arm for connecting with respect to the second surface of the ceramic block.

Having a connector that connects across the thickness of the ceramic block provides a stable and robust connection point.

The connector may be located at an end of the ceramic block. Providing the connector at the end means the connector aligns with the ceramic block giving a more robust connection and for heaters used within a fluid flow path, this forms less of a disturbance to fluid flowing from one end of the heater to the other.

The ceramic block may be formed from a plurality of layers of ceramic material. Such ceramic layers may be sheets, for example, produced by tape casting. When the ceramic material is in the green state individual sheets are formed which are then stacked on top of each other to produce the block. The at least one heater trace is formed from a conductive material such as tungsten or a mixture of tungsten and ceramic material. The at least one heater trace may be screen printed onto one of the layers of ceramic sheet that form the ceramic block. In this manner at least one heater trace is embedded within the ceramic block and when the ceramic block is sintered is integrally formed therein.

One of more of the first connecting arm and the second connecting arm may be recessed within the thickness of the heater coupon. The ceramic block may be provided with a first recess for accommodating the first connecting arm and a second recess for accommodating the second connecting arm. The first recess may extend from the first surface and the second recess may extend from the second surface.

This first recess may be of a depth such that the at least one heater trace is exposed to the connector and in particular the first connecting arm or the second connecting arm. In this embodiment, whilst both the first connecting arm and the second connecting arm form mechanical connections with the ceramic block only one of either the first connecting arm or the second connecting arm form an electrical connection with the at least one heater the trace.

The first recess may have a wall and a tab, the wall defining a depth of the recess within the ceramic block and delimiting an area of the tab and the tab providing a surface to which the first connecting arm can be attached. The first recess may extend from the first surface to the heater trace.

The second recess may have a wall and a tab, the wall defining a depth of the recess within the ceramic block and delimiting an area of the tab and the tab providing a surface to which the second connecting arm can be attached. The second recess may extend from the second surface to the heater trace.

Where the first recess may extend from the first surface and the heater trace is exposed to the first connecting arm, the first connecting arm provides both mechanical and electrical connection between the ceramic block and the connector and external wire. The second connecting arm provides mechanical connection only.

At least two connectors may be provided and the at least two connectors may be electrically isolated from each other.

A connector may further comprise a solder cup connected to both the first connecting arm and the second connecting arm. The solder cup is provided to attach an external wire to the connector.

The heater coupon is formed from a plurality of layers of ceramic material which may be tape cast and then stacked to form green state coupon. Whilst the plurality of layers is in the green state each layer is trimmed to the desired size and shape, including the provision of cut-outs or recesses to enable the connecting arms to be recessed into the ceramic block. The heater coupon additionally comprises coating layers that are added onto the ceramic block. Such coating layers may include a metallisation layer and a layer of braze filler, for example.

The at least one heater trace may be three heater traces. The three heater traces can be coplanar and in one embodiment the three heater traces follow similar paths. In this embodiment the three heater traces may extend from a single common connector providing a mains live connection into the ceramic block and then extend to individual neutral connectors which also connect to external wiring. Thus, the three heater traces are provided using four connection points on the ceramic block and four connectors. The live connector maybe larger than the neutral connectors. The three separate neutral connectors for each heater trace enable each heater each to be independently controlled to give a range of temperature settings.

The three heater traces extend from a first end of the ceramic block adjacent a first edge of the ceramic block towards a distal end then loop back towards the first end repeating this pattern a number of times until a second edge of the ceramic block is reached. In this embodiment, the live connector and the three neutral connectors are all located at the first end of the ceramic block.

At least two connectors may be provided and optionally each connector is electrically isolated from each other. The ceramic block may be provided with a through thickness slot between the at least two connectors. The through thickness recess slot extends from the first surface to the second surface. The through thickness slot enables electrical isolation of the whole connector. The through thickness slot enables heat shrink to be applied over a side of the slot, connector and the end of the external wire which electrically connects to the ceramic block.

The 0 v connection may have a larger through thickness slot to enable a larger area to be covered by the electrically insulating material. This ensures the temperature sensing is accurate as the chance of ingress of debris is minimised.

The ceramic block may additionally comprise an integrated thermal sensor such as an RTD (resistive temperature detector). The RTD measures the temperature within the ceramic block.

The RTD is formed from a conductive material such as tungsten or a tungsten and ceramic mixture. The RTD covers substantially all of the area of the ceramic block and may follow a different path to that the heater traces. One example is for the RTD to be formed from two substantially similar blocks of serpentine tracing.

Ceramic material is dielectric so the resistivity of the material changes with temperature. And this can affect the measurements taken by an integrated thermal sensor. The dielectric properties of the ceramic material can be improved i.e. made more constant by optimisation of the heater coupon through material selection and processing of the heater coupon from green state to sintered so the change in resistivity can be reduced. Alternatively or additionally, a ground shield layer may be also provided within the ceramic block. The ground shield layer is another trace that can be screen printed onto a layer of the ceramic material and this is connected to a 0 Volt supply and is located between the at least one heater trace and the RTD. The ground shield has a function of preventing any leakage current which passes through the ceramic block as the temperature rises from affecting the temperature recorded by the RTD.

An integrated thermal sensor may be formed within the ceramic block. The integrated thermal sensor may be connected to an external wire via a further connector. The further connector may comprise a first connecting arm for connecting with respect to the first surface and a second connecting arm for connecting with respect to the second surface of the ceramic block. The ceramic block may have a third recess for accommodating the first connecting arm of the further said connector and a fourth recess for accommodating the second connecting arm of the further said connector.

The third recess has a wall and a tab, the wall defining a depth of the recess within the ceramic block and delimiting an area of the tab and the tab providing a surface to which the first connecting arm of the further said connector can be attached. The fourth recess may extend from the second surface to the heater trace layer. The first connecting arm of the further connector will mechanically connect with the ceramic layer onto which the heater trace has been screen printed but the third recess does not provide access to or expose the heater trace.

The fourth recess may have a wall and a tab, the wall defining a depth of the recess within the ceramic block and delimiting an area of the tab and the tab providing a surface to which the second connecting arm of the further said connector can be attached. The fourth recess may extend from the second surface and the integrated thermal sensor is exposed to the second connecting arm of the further said connector. The fourth recess may extend from the second surface and in this example, the integrated thermal sensor is exposed to the second connecting arm. In this case, the first connector provides mechanical support whilst the second connector provides mechanical support and electrical connection between the integrated thermal sensor and an external wire. When an integrated thermal sensor is used, the supply is low voltage, around 3 to 5 v; two further connectors are required, the low voltage input and 0 v.

The connection is made from a conducting material whereas the ceramic block is an insulator, this leads to thermal mismatch when the heater coupon is heated due to them having different thermal heat capacities. To relieve the stresses on the connector, a strain relief may be provided. The strain relief is associated with the part of the connector which connects to the ceramic block. A number of different options are available for use but the principle of reducing the cross-sectional area of contact between the heater coupon and each connector arm is the same. In one embodiment, the connector arm comprises a generally rectangular form having a central recess where it connects to the heater coupon. In another embodiment, the connector arm has a hook shaped profile where it connects to the heater coupon.

The connectors are attached using brazing in this example so at least in the region of the connection, a braze filler is applied over a metallisation layer. In an embodiment where metal cooling fins are added to disperse heat generated by the heater coupon, the heater coupon additionally comprises a layer of braze filler applied over a metallisation layer for attachment for the cooling fins across one or more of the first surface and the second surface. The braze layer for both connectors and cooling fins are advantageously provided during a single process.

The first connecting arm and the second connecting arm may comprise strain relief features.

A heater as described may be used in a hair care appliance such as a hair dryer, hair styler or other heated hare care appliance.

According to a second aspect, there is provided a heater coupon comprising a ceramic block having a first surface and a second surface, at least one heater trace formed within the ceramic block and a connector for electrically connecting the at least one heater trace to a PCB (printed circuit board).

The connector may connect at one end to the heater coupon and at the other end to the PCB.

The connector may provide a direct connection between the heater coupon and the PCB.

The connector may comprise a first connecting arm for connecting with respect to the first surface of the ceramic block and a second connecting arm for connecting with respect to the second surface of the ceramic block.

The connector may be located at an end of the ceramic block.

The ceramic block may be formed from a plurality of layers of ceramic material.

The at least one heater trace may be screen printed onto one of the layers of ceramic sheet that form the ceramic block.

The ceramic block may be provided with a first recess for accommodating the first connecting arm and a second recess for accommodating the second connecting arm.

The first recess may have a wall and a tab, the wall defining a depth of the recess within the ceramic block and delimiting an area of the tab and the tab providing a surface to which the first connecting arm can be attached. The first recess may extend from the first surface to the heater trace.

The second recess may have a wall and a tab, the wall defining a depth of the recess within the ceramic block and delimiting an area of the tab and the tab providing a surface to which the second connecting arm can be attached. The second recess may extend from the second surface to the heater trace.

The first recess and the second recess may be substantially the same depth and area.

The at least two connectors may be provided and the at least two connectors are electrically isolated from each other.

An integrated thermal sensor may be formed within the ceramic block. The integrated thermal sensor may be connected to an external wire via a further said connector.

The second recess may extend from the second surface to the integrated thermal sensor.

The ceramic block may be provided with a third recess for accommodating the first connecting arm of the further said connector and a fourth recess for accommodating the second connecting arm of the further said connector.

The third recess may have a wall and a tab, the wall defining a depth of the recess within the ceramic block and delimiting an area of the tab and the tab providing a surface to which the first connecting arm of the further said connector can be attached.

The fourth recess may extend from the first surface to the heater trace layer.

The fourth recess may have a wall and a tab, the wall defining a depth of the recess within the ceramic block and delimiting an area of the tab and the tab providing a surface to which the second connecting arm of the further said connector can be attached.

The fourth recess may extend from the second surface and the integrated thermal sensor is exposed to the second connecting arm of the further said connector.

### BRIEF DESCRIPTION OF THE DRAWINGS

The invention will now be described by way of example, with reference to the accompanying drawings, of which:

FIG. 1a shows an isometric view of a heater within an enclosure;

FIG. 1b shows the isometric view of FIG. 1a with exploded parts;

FIG. 2a shows an isometric view of a heater coupon;

FIG. 2b shows the isometric view of FIG. 2a with exploded parts;

FIG. 3 shows an example of the layers within a heater coupon;

FIG. 4 shows an alternative layup for a heater coupon;

FIGS. 5a and 5b show ways in which the cooling fins can be attached to a heater coupon;

FIG. 6 shows a hairdryer in which a heater according to the invention can be used;

FIG. 7a shows a side view of a heater and connectors;

FIG. 7b shows an enlarged portion of FIG. 7a with some features removed;

FIG. 8 shows an isometric view of a connector connected to a heater coupon;

FIG. 9 shows a connector for use with a heater coupon;

FIG. 10 shows an alternative connector for use with a heater coupon;

FIG. 11a shows a third connector for use with a heater coupon;

FIG. 11b shows the third connector connected to a heater coupon;

FIG. 11c shows the third connector connected directly to a PCB;

FIG. 11d shows an alternative view of the third connector connected directly to a PCB;

FIG. 12 shows an example of an RTD trace; and

FIG. 13 shows an example of a heater trace.

### DETAILED DESCRIPTION OF THE INVENTION

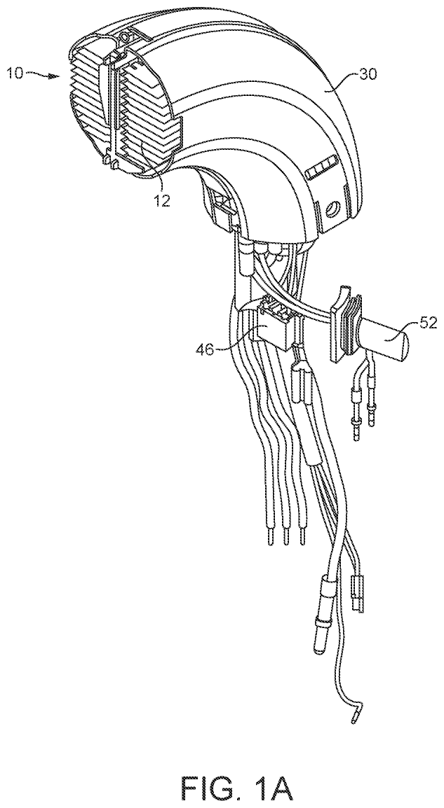

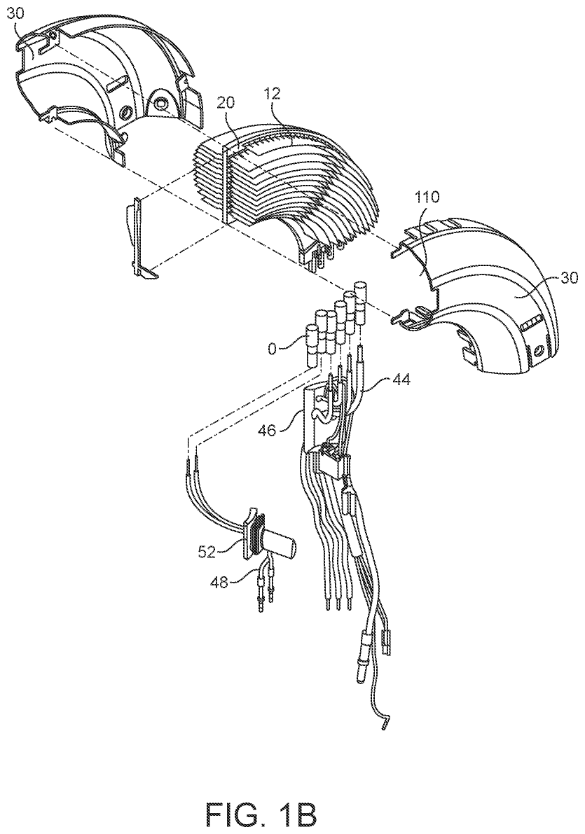

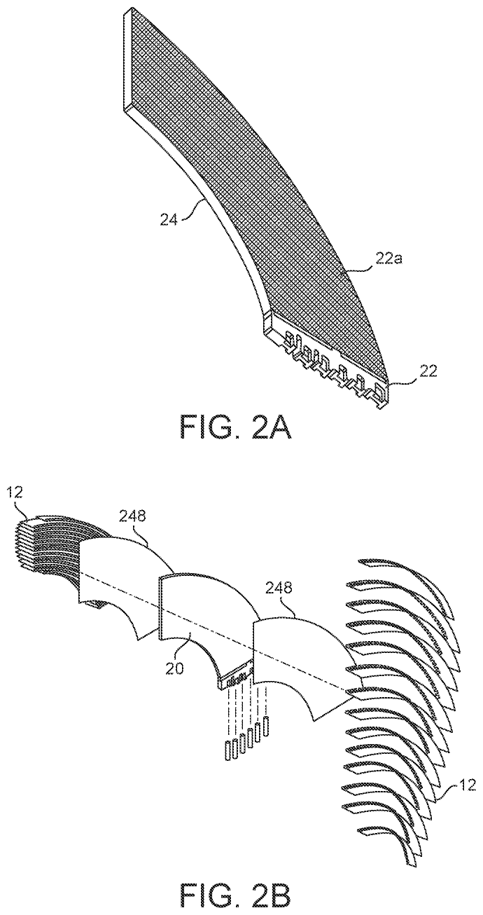

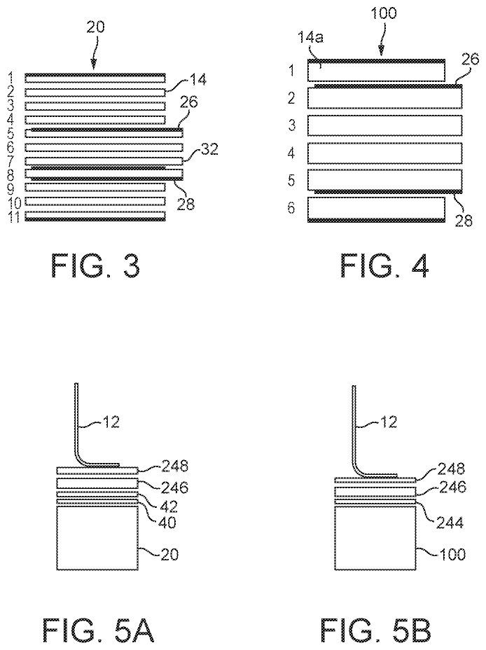

FIGS. 1 and 2 show a heater 10 housed within an enclosure 30. The heater 10 comprises a heater coupon 20 and a plurality of cooling fins 12. The heater coupon 20 as shown is a flat arch shaped article made from several layers of ceramic material stacked one on top of another forming a thickness t of the heater coupon 20 between a first surface 22 and a second surface 24. Specific examples of stacking arrangements will be discussed in relation to FIGS. 3 and 4.

The cooling fins 12 are attached to both the first surface 22 and the second surface 24 and extend orthogonally therefrom. In this example, the cooling fins 12 are stamped from a metal sheet and are brazed using a brazing paste or filler 248 to a metallised surface 22a of the heater coupon 20. The cooling fins 12 in this example are bent to follow the curve of the arch shaped heater coupon 20, however if the heater coupon were rectangular in shape the cooling fins could be straight.

Referring now to FIGS. 3 and 4, examples of the structure of a heater coupon 20, 100 will be discussed. A first embodiment comprises eleven layers 14 of a green state ceramic material which are stacked to form a heater stack. This heater stack is subsequently sintered to form the heater coupon. The ceramic material may be aluminium nitride, aluminium oxide, silicon nitride, silicon oxide or another suitable ceramic material and may comprise a mixture of materials dependent on the required properties. Within the heater coupon 20 is a resistive trace 26 which is the element of the heater 10—it heats up when energy is supplied and this heat is dissipated within the heater coupon 20 and the cooling fins 12. The resistive trace 26 is a continuous track of conductive material such as tungsten or a mix of tungsten and the ceramic material and can be screen printed onto a layer of ceramic within the heater stack.

Advantageously, the heater coupon 20 also houses an integrated thermal safety device such as an RTD 28 which comprises another continuous track of conductive material such as tungsten or a mix of tungsten and the ceramic material again applied by screen printing onto one of the ceramic layers. The temperature within the heater coupon can be inferred from a change in resistance of the RTD 28 as the temperature within the heater coupon 20 changes. Alternatively, an externally mounted thermal safety device which measures air temperature around the heater can be used.

The ceramic layers that have the resistive trace 26 or RTD 28 on them have portions which are exposed. One such portion is shown in FIGS. 3 and 4, the exposed portion creates a tab 80 enabling electrical connection of the resistive trace 26 or RTD 28 with a connector 60.

As the temperature of the heater coupon rises, the dielectric properties of the ceramic material may cause leakage current through the heater coupon as the ceramic becomes less insulating. This can affect the temperature reading inferred from the RTD, so in some circumstances a ground plane 32 is positioned within the heater stack between the resistive trace 26 and the RTD 28. The ground plane 32 is a trace that extends over the surface of a ceramic layer within the heater coupon and is connected to a 0 v connection. In the example shown in FIG. 3, the heater coupon 10 comprises four layers 14 of tape cast aluminium nitride, a fifth layer having the resistive trace 26 on the upper surface, two more layers 14 of tape cast aluminium nitride, an eighth layer having a ground plane 32 of the upper surface and an RTD 28 on the lower surface followed by three more layers 14 of tape cast aluminium nitride.

A second example is shown in FIG. 4 where the heater coupon 100 has fewer thicker layers of tape cast aluminium nitride and no ground plane as the dielectric properties of the ceramic material have been improved by optimising the composition of the material used. In this example the heater coupon 100 comprises one layer 14a of tape cast aluminium nitride, a second layer having the resistive trace 26 on the upper surface, two more layers 14 of tape cast aluminium nitride, a fifth layer having an RTD 28 on the lower surface followed by one more layer 14 of tape cast aluminium nitride.

The use of tape cast material is preferred as the thickness is easy to control and the green state ceramic can be cut to size and shape and stacked to form the heater stack prior to firing or sintering to form the heater coupon 20, 100.

With reference to FIGS. 5a and 5b the manner of attaching the cooling fins 12 will be discussed. For clarity only one side is shown in the drawings. The heater coupon 20 and metal cooling fins do not readily attach, and good adhesion is required to allow for thermal transfer from the heater coupon through the fins and into the air around the heater. To facilitate this the heater coupon 20 is metallised by applying a metal or metal-ceramic mixture to the first surface 22 and the second surface 24. Examples include a two layer system having a first metallisation surface 40 comprising a mixture of aluminium nitride and tungsten or molybdenum with the main component being aluminium nitride and a second metallisation surface 42 having a mixture of aluminium nitride and tungsten or molybdenum with the main component being tungsten or molybdenum. Alternatively, as shown in FIG. 5b a single metallisation layer 244 can be used.

Following metallisation, the first surface 22 and the second surface 24 are plated with, for example a Nickel Boron coating 246, a braze filler 248 is then applied to enable attachment of the cooling fins 12 to the outer surface of the heater coupon. The whole heater 10 can then be over plated for corrosion resistance or the cooling fins 12 can be plated prior to attaching to the heater coupon 20. An example of a braze filler is Nicusil from Morgan Advanced Materials although the skilled person will be aware of other suitable materials.

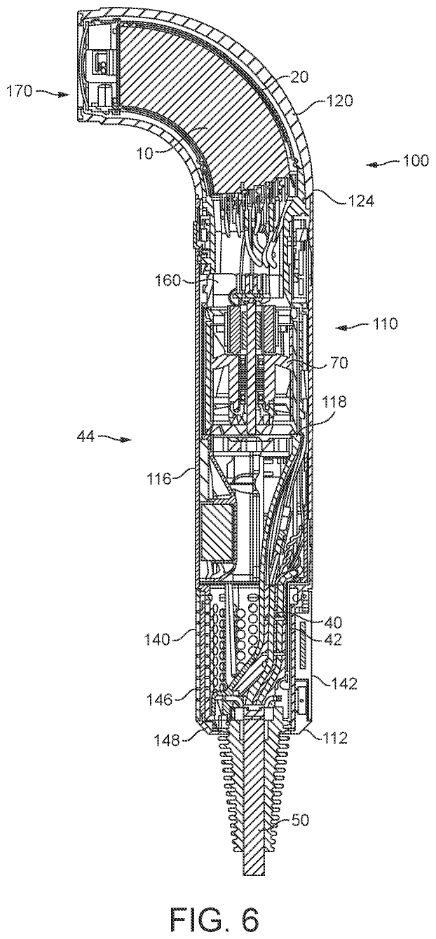

Referring now to FIG. 6, a hairdryer 100 is shown which incorporates the heater 10. The hairdryer 100 comprises a handle 110 which has a first end 112 which includes a fluid inlet 140 and a second end 124 which is connected to a further housing 120. Power is supplied to the hairdryer 100 via a cable 50. At a distal end of the cable 50 from the hairdryer 10 a plug (not shown) is provided, the plug may provide electrical connection to mains power or to a battery pack, for example there may be an electronic control box located on the cable between the hairdryer and the plug or battery pack. Alternatively, the plug may contain certain electronic components. The fluid inlet 140 is provided with a filtering system which includes two or three layers of filtration. In this example, an external layer of the filtering system is formed by a removable filter grille 142.

The handle 110 has an outer wall 116 and in this example an external surface of the filter grille 142 and the outer wall 116 have the same diameter so the profile of the handle is constant from the first end 112 to the second end 114 of the handle 110. Alternatively, the filter grille 142 has a larger diameter than the handle 110 which enables more filtering media to be provided; this is particularly useful if the hairdryer is used often for example, in a salon. The filter grille 142 comprises an array of apertures 146 that extend in a series of rows and/or columns and an end wall 148 which extends radially inwards from the external surface 142. The cable 50 enters the hairdryer through an aperture 150 in the end wall 148. The cable 50 is located approximately in the middle of the end wall 148 so extends from the centre of the handle 110.

The filter grille 142 helps to prevent hair and other foreign objects from entering the fluid flow path 160 of the hairdryer and provides a coarse filtering stage; the apertures 146 have a diameter of around 2.8 mm (2800 microns).

Upstream of the fluid inlet 140, a fan unit 70 is provided. The fan unit 70 includes an impeller and a motor. The fan unit 70 draws fluid into the fluid inlet 110 through a fluid flow path 160 that extends from the fluid inlet 110 around a heater 10 and to a fluid outlet 170 from the further housing 120 where fluid that is drawn in by the fan unit exits the fluid flow path 160. The fluid flow path 160 is non-linear and flows through the handle 110 in a first direction and through the further housing 120 in a second direction which is angled to the first direction. The further housing 120 is curved, in this example the fluid outlet 170 is orthogonal to the fluid inlet 140. Within the further housing 120, the fluid flow path is turned by 90°.

The heater 10 in this embodiment, is located within the further housing 120 however, as the skilled person will appreciate, the heater could alternatively be located within the handle. The fluid flow path could be turned by any angle or indeed be linear, 90° is found to be convenient for the user as the outlet naturally points towards a user's head.

The cable 50 provides power into the hairdryer 100 and a wiring loom 40 extends from the cable through a wire guide 42 within the hairdryer 100 towards the fan unit 70 and the heater 10. Within the wiring loom 40, a pair of wires are provided for the fan unit 70, four wires are provided for the heater trace 26 and two for the RTD trace 28. The handle 110 comprises an inner wall 118 which extends from the fluid inlet 140 within the outer wall 116 to the second end 114 of the handle 110. The inner wall 118 retains the wire guide 42 and routes the wiring loom 40 from the cable to an outer surface of the inner wall 118 where the wiring loom 40 is split and the wires for the different functions are routed along and around the inner wall 118 between the inner wall 118 and the outer wall 116.

For the heater 10, the heater trace wiring 44 extends between the inner wall 118 and the outer wall 116 passed the fan unit 70 and then an aperture in the inner wall 118 provides access into the fluid flow path 160. A rubber grommet 46 seals around the heater trace wiring 44 and the aperture preventing fluid moving between the space between the inner wall 118 and the outer wall 116 and the fluid flow path 160. The RTD wiring 48 also extends between the inner wall 118 and the outer wall 116 passed the fan unit 70 and then a second aperture in the inner wall 118 provides access into the fluid flow path 160. A rubber grommet 52 seals around the RTD wiring 48 and the aperture preventing fluid moving between the space between the inner wall 118 and the outer wall 116 and the fluid flow path 160. Wire guides (not shown) are moulded on the outer surface of the inner wall 188 to locate and guide wiring within the hairdryer.

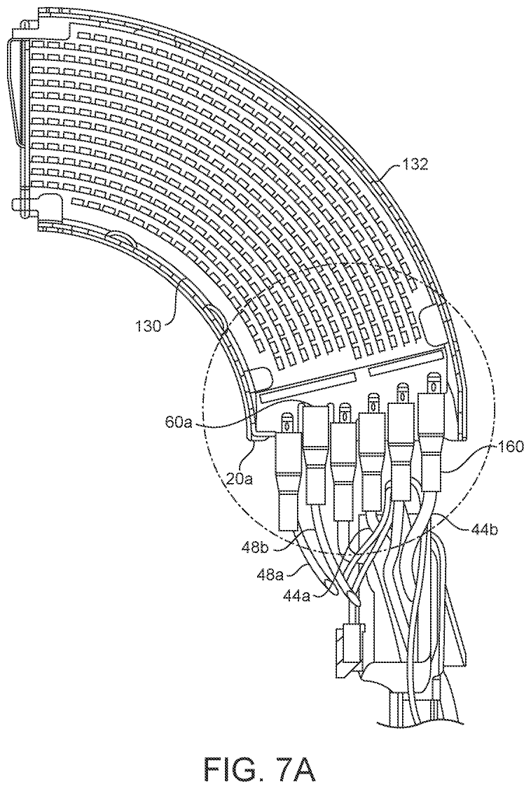

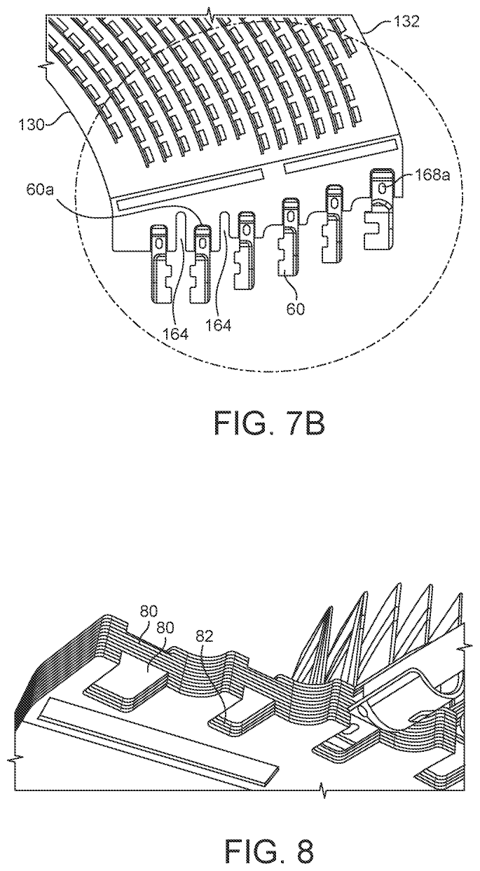

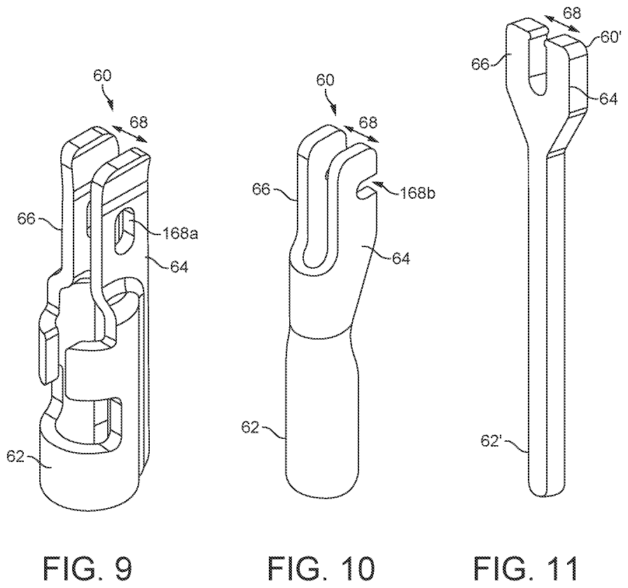

The heater trace wiring 44 connects to the heater coupon 20 via connectors 60 these will be discussed with reference to FIGS. 7a, 7b and 9 in particular. The connectors 60 have three parts, a solder cup 62 for receiving and retaining a wire 44a, 44b of the heater trace wiring 44, a first connecting arm 64 and a second connecting arm 66 for connection to the heater coupon 20. The first connecting arm 64 and the second connecting arm 66 are designed to sandwich the heater coupon 20 between them. Thus, each connector 60 provides a mechanical key to the heater coupon 20.

The heater coupon 20 is formed from a stack of ceramic layers which are cut to the desired shape and configuration whilst in the green state. Where each connector 60 is to be fixed to the heater coupon 20 a pair of tabs 80 is provided. A tab is formed by cutting back the layers between the tab 80 and a surface to expose the relevant layer. Any layers of the ceramic between the location of the tab 80 and either the first surface 22 or the second surface 24 of the heater coupon are cut away at the tab location which forms a pair of recesses 82 and this exposes the pair of tabs 80 at an end of the heater coupon. The recesses 82 are defined by a wall defining a depth of the recess within the ceramic block and delimiting an area of the tab 80 and the tab providing a surface to which a connecting arm can be connected. The first connecting arm 64 and the second connecting arm 66 are sized to fit within the recesses 82, the first connecting arm 64 and the second connecting arm 66 can slide along the pair of tabs 80 into the recesses 82 for electrical connection to the heater trace 26. Each layer of ceramic is cut to the required shape by a tool akin to a cookie cutter.

The heater trace wiring 44 has four wires as in this example there are three heater traces within the heater coupon. All three heater traces 26a, 26b, 26c are screen printed onto the same ceramic layer and share a common live wire 44b into the heater coupon 20 with individual neutral connections at their respective distal ends to enable connection to three neutral wires 44a. The heater traces 26a, 26b, 26c all follow a common route around the heater coupon and are formed by screen printing a mixture of a metallic element such as tungsten with the ceramic material used in the heater coupon. Connection between the heater trace wiring 44 and the resistive trace 26 is via pads 126 which are enlarged areas of the resistive trace material configured to fill the tabs 80 defined by a respective recess 82 to enable a good electrical connection between a wire 44 and the resistive trace 26.

The heater traces do not need to be screen printed on the same ceramic layer, there can be more or fewer heater traces dependent on temperature requirements; there can be any combination of traces on different layers. For this embodiment, using a single ceramic layer for all heater traces simplifies the wiring loom as a single live wire can be routed through the product from the cable 50 and is split within the heater coupon 20.

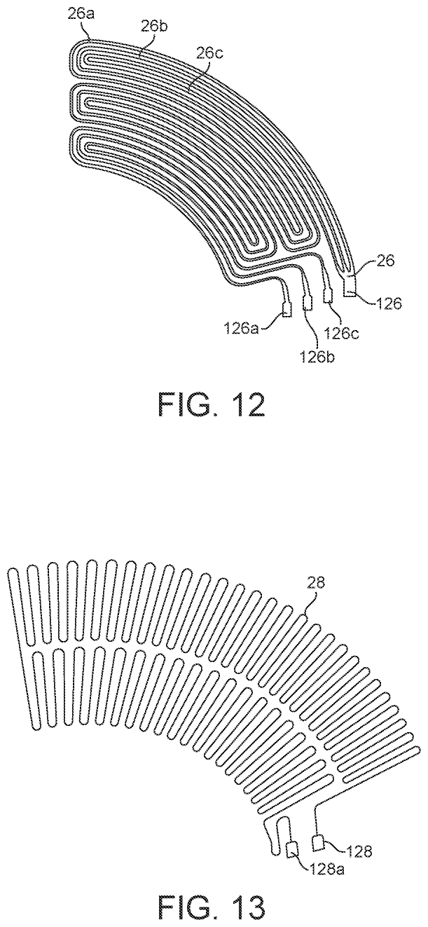

Referring to FIG. 12, the heater trace 26 has a first pad 126 which corresponds to the location of a tab 80. This first pad 126 provides a connection area for the live wire 44b of the heater via a connector 60. The first pad 126 is exposed as an external surface within a recess 82 for connection to a connector 60. The first pad 126 splits into three substantially similar traces 26a, 26b, 26c which follow a serpentine path through the heater coupon 20 to second, third and fourth pads 126a, 126b, 126c each corresponding to a respective trace 26a, 26b, 26c and being exposed for connection to a connector 60 as each aligns with a respective tab 80 of the heater coupon 20. The second, third and fourth pads 126a, 126b, 126c each connect, via a connector 60 to one of three neutral wires 44a. Thus, four pairs of tabs 80 are provided on the heater coupon 20 for the resistive trace 26.

One of each pair of tabs 80 exposes a pad 126, 126a, 126b, 126c within a respective recess 82 thus either the first connecting arm 64 or the second connecting arm 66 of a connector 60 connects to the resistive trace 26. The other one of the first connecting arm 64 or the second connecting arm 66 lies within a corresponding recess 82 which extends from the other surface of the ceramic coupon and connects to exposed ceramic material formed as a tab 80. Thus, one arm provides electrical connection and both provide mechanical connection between the heater coupon 20 and the connectors 60.

All electrical connection to the heater trace 26 is provided by one of the first connecting arm 64 or the second connecting arm 66. The other of each pair of tabs 80 is provided with a braze pad (not shown) which facilitates the mechanical connection of the metal connector to the ceramic heater coupon 20. The braze pad is sized to fit within the recess 82 and is formed of the same material as the heater track 26 and RTD 28. Ideally, the braze pads are screen printed onto the relevant layer of ceramic material at the same time as the heater track 26 and RTD 28. The braze pads are discrete and do not provide an electrical connection.

Referring to FIG. 11, details of the RTD 28 will be discussed. The RTD 28 is a resistive trace which can be of the same composition as the heater trace 26 or can have a different proportion of ceramic and tungsten. The RTD 28 is screen printed onto a layer of the ceramic material in the same manner as the heater trace 26 and this layer is located at a different position within the heater stack to the heater trace 26. Ideally, the RTD 28 covers substantially all of a cross-sectional area of the heater coupon 20. This ensures that if there are temperature hot spots within the heater coupon 20 they are picked up by the RTD 28. In this example, the RTD 28 has a pattern which is different to that of the heater trace 26. Power is supplied to the RTD 28 via RTD wiring 48 which consists of a live wire 48b and a OV wire 48a. The RTD 28 includes a first RTD pad 128 and a second RTD pad 128a from which the connections to the RTD wiring 48 are made. The first RTD pad 128 and the second RTD pad 128a are exposed for connection to a connector 60 and each align with a recess 82 and a respective pair of tabs 80.

In this embodiment, the heater trace 26 is exposed with respect to a first surface 22 of the heater coupon 20 and thus electrical connection is made via the first connecting arm 64. Advantageously, the RTD 28 is exposed with respect to a second surface 24 of the heater coupon 20 and thus electrical connection is made via the second connecting arm 66. For both the heater trace 26 and the RTD 28 both the first connecting arm 64 and the second connecting arm 66 provide mechanical connection between a connector 60 and the heater coupon 20.

Having the RTD pads 128, 128a exposed on a different surface to the heater trace pads 126, 126a, 126b, 126c means that on each side of the heater coupon 20, the recesses can be of a uniform depth. A recess on the first surface 22 may be a different thickness to a recess on the second surface 24 or they may be substantially the same depth. This means all the connectors 60 are aligned with respect to each other and the heater coupon 20. All the tabs 80 and recesses 82 are spaced along one end of the heater coupon 20 with full thickness parts of the heater stack in-between to provide electrical insulation.

Examples of connectors 60 are shown in FIGS. 9, 10 and 11. There are two broad types. In FIGS. 9 and 10, the connectors 60 are designed to attached at one end to the heater coupon 20 and at the other end to a wire 44, 48. Both of these connectors 60 have a solder cup 62 which is connected to a first connecting arm 64 and a second connecting arm 66 which extend from generally opposing sides of the solder cup 62 forming a gap 68 between them. The gap 68 extends along the length of the first connecting arm 64 and the second connecting arm 66 forming a space within which the heater coupon 20 and in particular, the tabs 80 can be located when a connector 60 is attached to the heater coupon 20.

The recess 82 formed around each tab 80 is sized to house the first connecting arm 64 or the second connecting arm 66. The first connecting arm 64 and the second connecting arm 66 are either flush with the first surface 22 and the second surface 24 respectively or as shown in FIG. 8 recessed within the thickness t of the heater coupon 20.

The connectors 60 are made from metal as they form part of the circuit between the wiring loom and the heater coupon 20. The metal is chosen to be one with a low thermal expansion as the ceramic material has a low thermal expansion coefficient and this reduces thermal mismatch as the heater 10 is heated. A metal such a Kovar is suitable and the skilled person will be aware of other suitable metal materials. Even with the thermal mismatch being reduced, the connector 60 will expand more than the ceramic heater coupon 20. For this reason, the connector 60 may be provided with strain relief features 168a, 168b. The strain relief features 168a, 168b are designed so there is good electrical connection between the first connecting arm 64 or the second connecting arm 66 with the tab 80 without undue strain on the ceramic heater coupon 20 during heating cycles. One strain relief feature 168a is an aperture cut within the part of the connector 60 which attaches to the heater coupon 20; another example of a strain relied feature 168b is to form the connection as a hook with the hollow formed as part of the hook providing the strain relief. Each maintains sufficient mechanical and electrical connection whilst not covering the whole cross section of overlap between the connector 60 and the heater coupon 20.

A second type of connector 60′ connects directly into a receptacle 90 on a PCB 92, so instead of a solder cup 62, connector 60′ has a shaft 62′ at the distal end from the first connecting arm 64 and the second connecting arm 66. Referring to FIGS. 11b and 11c, the first connecting arm 64 and the second connecting arm 66 sit within recesses formed in the heater coupon 60. In this example the first connecting arm 64 and the second connecting arm 66 sit proud of the first surface 22 and the second surface 24. The first connecting arm 64 and the second connecting arm 66 are connected to a shaft 62′ which is housed in a receptacle 90 connected to a PCB 92.

The first RTD pad 128 and the second RTD pad 128a are both located, as with the heater trace pads 126, 126a, 126b, 126c, at one end 20a of the heater coupon 20. Each of the pads is spaced along the length of the end 20a of the heater coupon 20. Advantageously, the RTD pads 128, 128a are located adjacent a first edge 130 and the heater pads 126, 126a, 126b, 126c extend along from a second edge 132 of the heater coupon. This means the wiring for the RTD 28 and the heater trace 26 can be channeled separately within the appliance and exit the fluid flow path 160 adjacent a respective edge of the heater coupon 20.

Each connector 60 is electrically isolated from the fluid flow path 160 by applying a heat shrink 162 over at least a portion of the length of the connector 60. The heat shrink 160 is a tube which fits over the solder cup 62 and at least partially along the first connecting arm 64 and the second connecting arm 66. For most of the connectors 60, the heat shrink 160 abuts the end 20a of the heater coupon 20. However, for the RTD live in wire 48b which connects to RTD pad 128a, the heat shrink extends to the distal end of the connector 60a. This is to ensure that no debris within the fluid flow path 160 can cause a short to this connection as it is part of the thermal safety system for the appliance. In order to facilitate the location of the heat shrink 160, the end 20a of the heater coupon 20a is cut back so the heater coupon 20 is at the same level with respect to the connector 60 at both sides. In the case of the live RTD wire 48b, a slot 164 is formed in the heater coupon 20 on either side of the connector 60.

Whilst particular examples and embodiments have been described, it should be understood that various modifications may be made without departing from the scope of the invention as defined by the claims

1. A heater coupon comprising a ceramic block having a first surface and a second surface, at least one heater trace formed within the ceramic block and a connector for electrically connecting the at least one heater trace to an external wire wherein the connector comprises a first connecting arm for connecting with respect to the first surface and a second connecting arm for connecting with respect to the second surface of the ceramic block.

2. The heater coupon according to claim 1, wherein the connector is be located at an end of the ceramic block.

3. The heater coupon according to claim 1, wherein the ceramic block is formed from a plurality of layers of ceramic material.

4. The heater coupon according to claim 3, wherein the at least one heater trace is screen printed onto one of the layers of ceramic sheet that form the ceramic block.

5. The heater coupon according to claim 1, wherein the ceramic block is provided with a first recess for accommodating the first connecting arm and a second recess for accommodating the second connecting arm.

6. The heater coupon according to claim 5, wherein the first recess extends from the first surface.

7. The heater coupon according to claim 5, wherein the first recess is of a depth such that the at least one heater trace is exposed to the connector and in particular the first connecting arm or the second connecting arm.

8. The heater coupon according to claim 5, wherein the first recess has a wall and a tab, the wall defining a depth of the recess within the ceramic block and delimiting an area of the tab and the tab providing a surface to which the first connecting arm can be attached.

9. The heater coupon according to claim 5, wherein the first recess extends from the first surface to the heater trace.

10. The heater coupon according to claim 5, wherein the second recess has a wall and a tab, the wall defining a depth of the recess within the ceramic block and delimiting an area of the tab and the tab providing a surface to which the second connecting arm can be attached.

11. The heater coupon according to claim 5, wherein the second recess extends from the second surface to the heater trace.

12. The heater coupon according to claim 5, wherein the first recess extends from the first surface and the heater trace is exposed to the first connecting arm.

13. The heater coupon according to claim 1, wherein at least two connectors are provided and the at least two connectors are electrically isolated from each other.

14. The heater coupon according to claim 1, wherein a connector further comprises a solder cup connected to both the first connecting arm and the second connecting arm.

15. The heater coupon according to claim 13, wherein the ceramic block is provided with a through thickness slot between the at least two connectors.

16. The heater coupon according to claim 1, wherein the ceramic block additionally comprises an integrated thermal sensor such as an RTD (resistive temperature detector).

17. The heater coupon according to claim 16, wherein the integrated thermal sensor is connected to an external wire via a further connector.

18. The heater coupon according to claim 17, wherein the further connector comprises a first connecting arm for connecting with respect to the first surface and a second connecting arm for connecting with respect to the second surface of the ceramic block.

19. The heater coupon according to claim 17, wherein ceramic block has a third recess for accommodating the first connecting arm of the further said connector and a fourth recess for accommodating the second connecting arm of the further said connector.

20. The heater coupon according to claim 17, wherein third recess has a wall and a tab, the wall defining a depth of the recess within the ceramic block and delimiting an area of the tab and the tab providing a surface to which the first connecting arm of the further said connector can be attached.

21. The heater coupon according to claim 1, wherein the first connecting arm and the second connecting arm comprise strain relief features.
